(19) United States
(12) Patent Application Publication
(10) Pub. No.: US 2015/0278744 A1
(43) Pub. Date: Oct. 1, 2015

(54) ANALYTICS AND REPORTING TOOL FOR HUMAN CAPITAL MANAGEMENT (HCM)

(71) Applicants: Yonghui WANG, Shanghai (CN); Jingjing GUO, Shanghai (CN); Tong LIN, Shanghai (CN); Peter Enrico VITTORIA, Neckargemund (DE); Judith RÖSS, Heidelberg (DE); Stefan EHRLER, Biblis (DE); Alexander SCHMITT, Bad Schonborn (DE)

(72) Inventors: Yonghui WANG, Shanghai (CN); Jingjing GUO, Shanghai (CN); Tong LIN, Shanghai (CN); Peter Enrico VITTORIA, Neckargemund (DE); Judith RÖSS, Heidelberg (DE); Stefan EHRLER, Biblis (DE); Alexander SCHMITT, Bad Schonborn (DE)

(21) Appl. No.: 14/226,779

(22) Filed: Mar. 26, 2014

(51) Int. Cl. G06Q 10/06

(52) U.S. Cl. CPC G06Q 10/06393

(57) ABSTRACT

Described herein is a reporting framework. In accordance with one aspect of the framework, data is modeled into business-oriented data, wherein the data utilizes flat-table data modules. A subset is selected from the business-oriented data, and a dataset may be retrieved based on the subset. The retrieved dataset may be converted into structured query language (SQL) expression, which is then used to report the dataset.

### TECHNICAL FIELD

The present disclosure relates generally to an analytics reporting tool that utilizes a business-oriented model data structure.

### BACKGROUND

Human Capital Management (HCM) is a strategic and coherent approach to management of people working for an organization. For example, one goal of the HCM is to help the organization meet strategic goals by attracting and maintaining employees. Another goal of HCM is to manage these employees effectively.

Data in HCM has high analyzing value. For example, the data persist on both master and transactional human capital data, which is an important asset to a company. Management in the company typically demands quick, transparent knowledge of this data. For example, key performance indicators (KPIs) such as average age, leave rate, female manager percentage, are commonly seen. In this example, the KPIs differ in different organization hierarchy and different management member cares for different scale of the same KPI.

With the changing business environment, human resources (HR) professionals/administrators, for example, may have changing requirements for business insight on the HCM data and react in different business contexts. Pre-developed or designed report or analytics content do not cover or address such reactions/changes from the HR professional. As such, the HR professional, for example, would like to be empowered to manage the business insight efficiently with least effort and without relying on information technology (IT) department.

### SUMMARY

A reporting framework is described herein. In accordance with one aspect of the framework, data is modeled into business-oriented data, wherein the data utilizes flat-table data modules. A subset is selected from the business-oriented data, and a dataset may be retrieved based on the subset. The retrieved dataset may be converted into structured query language (SQL) expression, which is then used to report the dataset.

This summary is provided to introduce a selection of concepts in a simplified form that are further described below in the following detailed description. It is not intended to identify features or essential features of the claimed subject matter, nor is it intended that it be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates an exemplary graph that illustrates a comparison of different reporting tools;

FIG. 2 illustrates an exemplary human capital management (HCM) system used in accordance with the technology described herein;

FIG. 3 illustrates an exemplary landscape overview for implementing a reporting tool used in accordance with the technology described herein;

FIG. 4 illustrates an exemplary modeling of data used in accordance with the technology described herein;

FIG. 5 illustrates another exemplary database table used in accordance with the technology described herein;

FIG. 6 illustrates an exemplary scenario for a selection of a subset;

FIG. 7 illustrates an exemplary implementation of generating structured query language (SQL) expression used in accordance with the technology described herein;

FIG. 8 illustrates an exemplary process used in accordance with the technology described herein; and

FIG. 9 illustrates an exemplary computing system to implement in accordance with the technologies described herein.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

Disclosed herein are technologies for a flexible analytics reporting tool that a user may utilize for managing an organization. Examples of users include individuals, businesses or corporate entities, etc. Technologies herein may be applied to computing and mobile applications.

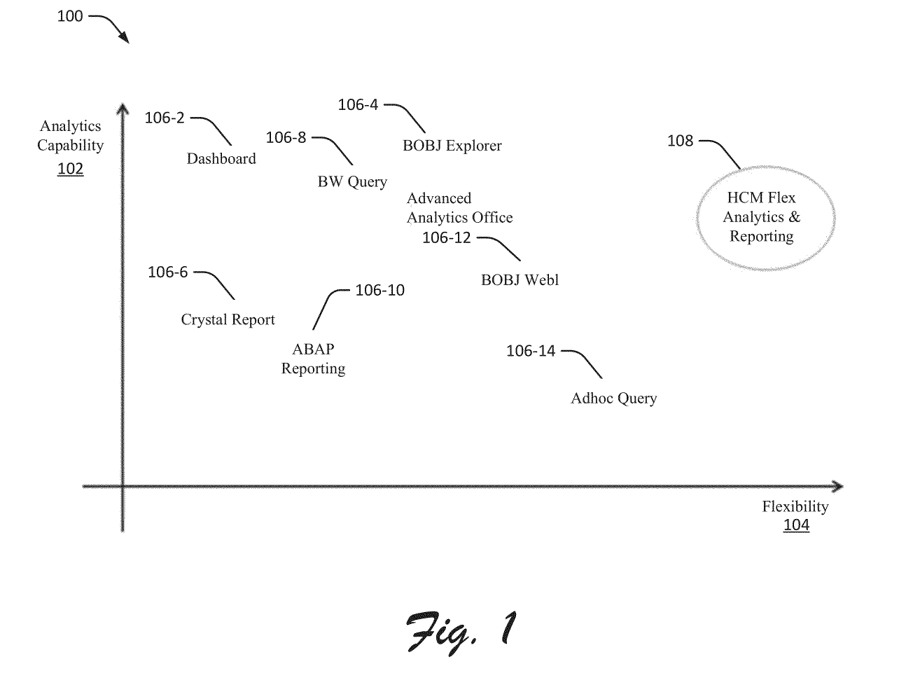

FIG. 1 shows an example graph 100 that illustrates comparison of different reporting tools. The graph 100, for example, shows analytics capability (i.e., analytics capability 102) versus flexibility (i.e., flexibility 104) of different reporting tools.

The analytics capability 102, for example, includes the type of KPIs, aggregation function, calculation function and visualization that are supported by the reporting tool (e.g., reporting tool 106). On the other hand, the flexibility 104 is the extent or limit of what business-users (not shown) may compose, combine dataset, generate reporting and analytical result without the need of IT supports.

For example, a dashboard 106-2 is web-based software that displays data in real time from databases, data warehouses and other data sources in a single location. In this example, the dashboard 106-2 targets end-user (not shown) with pre-designed analytics result and formatted report (i.e., high analytics capability 102); however, the dashboard 106-2 generates report based on the data displayed on the dashboard and thus, has a smaller or least flexibility 104.

Similarly, BusinessObjects (BOBJ) explorer 106-4, Crystal Report 106-6, Business Information Warehouse (BW) Query 106-8, ABAP Reporting 106-10, etc. have separate individual models and dataset. Thus, the end-users may spend a high cost to generate analytics report across different dataset with these reporting tools. For example, the BusinessObjects (BOBJ) explorer 106-4 targets the end-users with exploring capability and to some extent, has some flexibility when drilled down to a specific report; however, the flexibility 104 for the BOBJ explorer 106-4 is limited by a pre-defined Data Model (i.e., BOBJ Universe). The BOBJ Universe, for example, is a semantic layer that resides between an organization's database and the end-users.

In an implementation, a HCM flex analytics and reporting 108 is a reporting tool that is configured to have high analytics capability 102 and flexibility 104. For example, as further discussed below, the HCM flex analytics and reporting 108 utilizes a business-oriented model data structure in order to obtain flexibility in addition to its substantially high analytics capability.

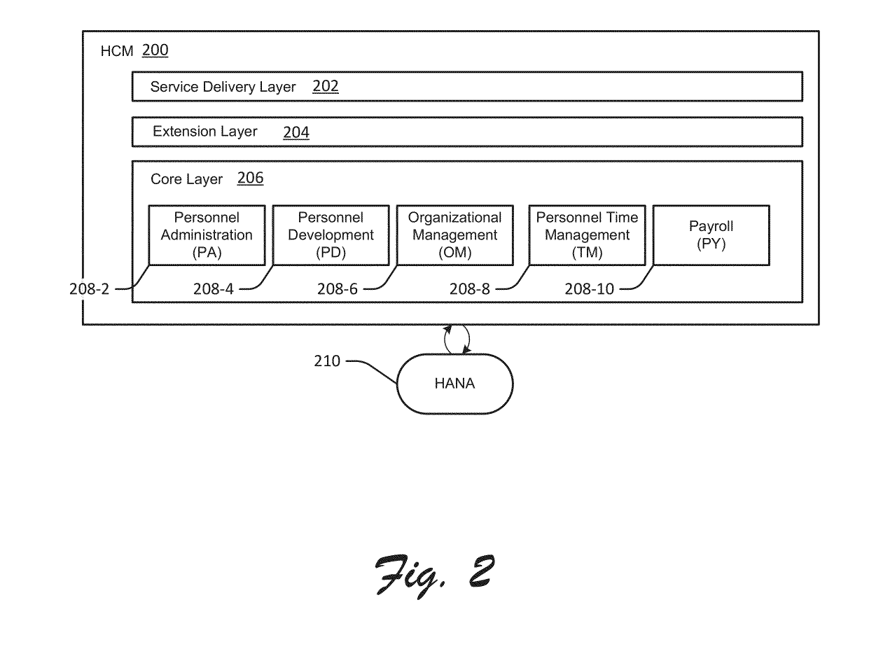

FIG. 2 shows an example HCM system 200 that may be used in the reporting tool as described herein. For example, the HCM system 200 is a component of the HCM flex analytics and reporting 108.

As shown, the HCM system 200 has a service delivery layer 202, an extension layer 204, a core layer 206, and other optional components. In the embodiments described herein, the core layer 206 includes data that is common or typical of HCM data. The service delivery layer 202 and the extension layer 204 are associated to the core layer 206. Thus, the embodiments described herein may relate substantially to the core layer 206.

The core layer 206, for example, has five modules 208 for the HCM data. The modules 208 are Personnel Administration (PA) 208-2, Personnel Development (PD) 208-4, Organizational Management (OM) 208-6, Personnel Time Management (TM) 208-8, and Payroll (PY) 208-10.

In an implementation, the data of the PA 208-2, PD 208-4 and OM 208-6 are organized in a unit of data and referred to as INFOTYPE. One INFOTYPE defines a unit of semantically related data. Furthermore, each INFOTYPE has a database table that follows the same pattern. For example, every INFOTYPE is named with 4 (four) digits. In this example, the different modules PA 208-2 and PD 208-4 may reserve different number range of INFOTYPE as listed below:
0000-0999 is reserved for PA 208-2
1000-1999 is reserved for PD 208-4

For the above range of INFOTYPE, two specific INFOTYPEs for PD 208-4, for example, may maintain all business objects. For example, INFOTYPE 1000 stores all the business objects such as Employee, Position, Job, and Organizational Unit, while INFOTYPE 1001 maintains relationships of one business object to another business object. In another example, INFOTYPE 1001 may contain which organizational unit an Employee belongs to, the position he holds, the manager of one organizational unit, etc. The rest of the INFOTYPEs may contain attributes of the business object.

In an implementation, each INFOTYPE is a flat database table. In other words, the INFOTYPE uses a single table to store all relevant data. In a high performance analytic appliance (HANA) relational database (e.g., HANA 210) that utilizes in-memory and column-base orientation, the flat database table may facilitate real time analysis of data. Furthermore, the real-time analysis may be supported by Virtual Data Model (VDM) feature of the HANA 210.

In an implementation, all INFOTYPEs in the PA 208-2 belong to business object Employee. On the other hand, the OM 208-6 may be a subset of objects in the PD 208-4 and can be organized in hierarchy, including organizational unit, position, task, etc. To this end, the modules PA 208-2, PD 208-4 and OM 208-6 may be transformed into business-oriented object data models. For example, business-oriented object models are Employee, Organizational Unit, Position, etc. that are stored in the INFOTYPE 1000.

With continuing reference to FIG. 2, the modules TM 208-8 and PY 208-10 are both consolidated and transactional data. Furthermore, the modules TM 208-8 and PY 208-10 are implemented in flat-table modules similar to the modules PA 208-2, PD 208-4 and the OM 208-6 above. As such, the HANA relational database (i.e., HANA 210) may perform real-time analysis on the modules TM 208-8 and PY 208-10.

Furthermore, the data of modules TM 208-8 and PY 208-10 have reference to Employee ID such as a personnel number. As such, the TM 208-8 and PY 208-10 may be treated as attributes of the business object Employee. Similarly, the TM 208-8 and PY 208-10 may be aggregated by the relation of the Employee to other objects like an Organizational Unit. Thus, the data in the modules TM 208-8 and PY 208-10 may be attached to the business object Employee by using, for example, the HANA relational database.

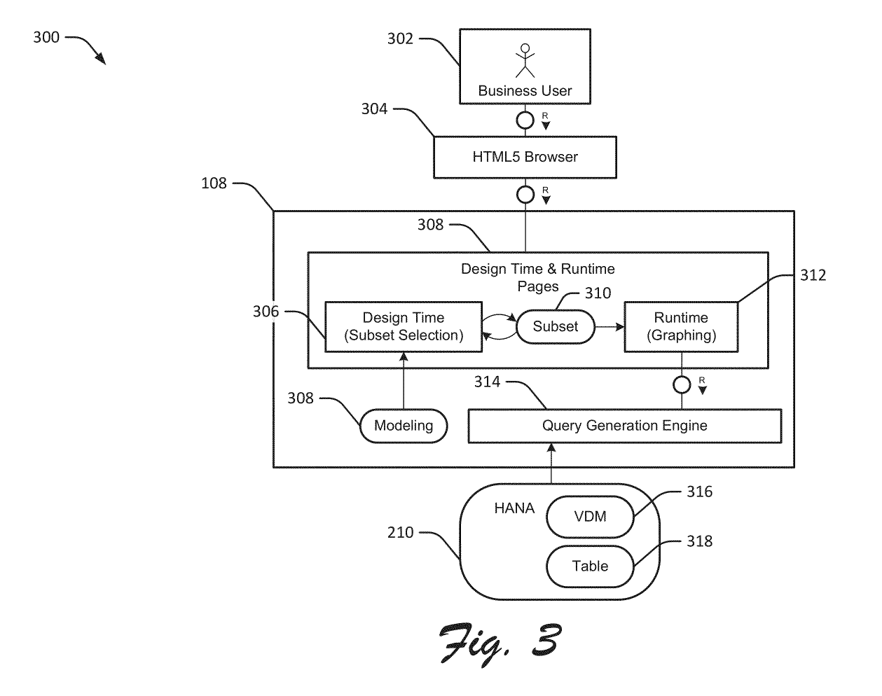

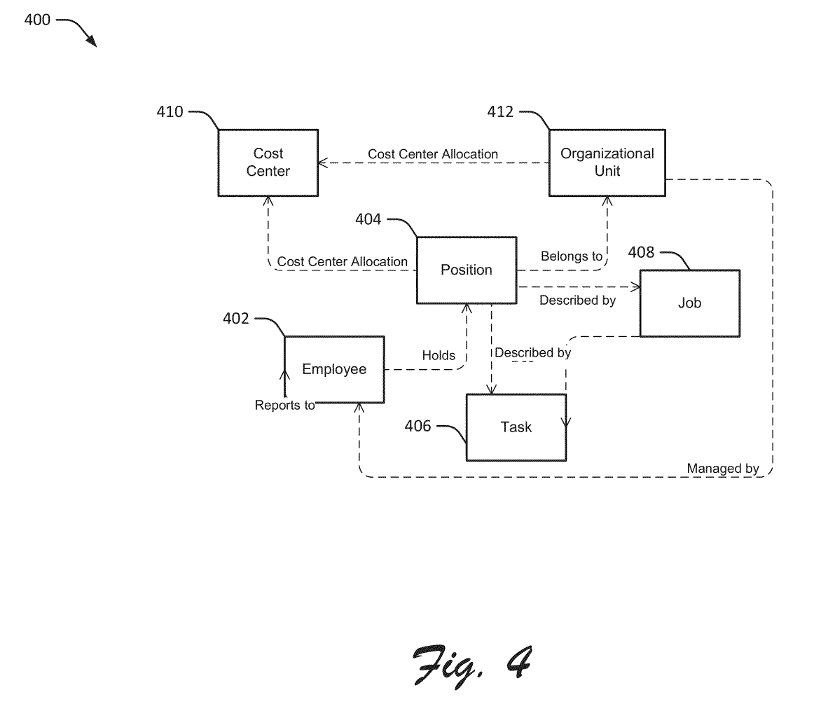

FIG. 3 shows an example landscape overview 300 for implementing the reporting tool as described in the present implementations herein. In an implementation, the landscape overview 300 adopts four basic concepts. The first concept involves modelling business-oriented objects with KPIs; the second concept relates to subset selection; the third concept relates to Query Generation Engine; and the fourth concept relates to reporting. These four basic concepts are further discussed with reference to FIGS. 4-6.

With continuing reference to FIG. 3, the landscape overview 300 shows a business user 302 accessing the reporting tool (e.g., HCM flex analytics and reporting 108) via a web browser such as an HTML5 Browser 304. Pages of the HCM flex analytics and reporting 108, for example, have areas such as a design time 306. The design time 306 component shows, for example, the business-oriented HCM data structure model from modeling 308. The modeling 308 component, for example, utilizes the flat-table data modules 208 and models these data modules into business-oriented data.

From the page of the design time 306, the business-user 302 may select a subset 310 of the business-oriented HCM Model supplied by the modeling 308. For example, the business-user 302 selects needed KPIs and dimensions that are a subset of the whole model in the design time 306. In this example, a runtime 312 displays a final report as requested by the business-user 302.

In an implementation, the business-user 302 may hit, for example, a report generation button (not shown). In this implementation, the runtime 312 may send the subset 310 to a Query Generation Engine 314 that translates the subset 310 into a structured query language (SQL) query. Furthermore, the Query Generation Engine 314 requests resulting dataset from database 210 and feeds back the dataset to the runtime 312 (e.g., user interface (UI)). The Query Generation Engine 314 may further convert the dataset into SQL expression for consumption of other third-party reporting tools. The runtime 312 may afterwards graph the dataset for use of the business-user 302.

In an implementation, the database, 210, for example, includes a VDM 316 and flat tables 318 to implement real-time analysis of data for the HCM flex analytics and reporting 108.

FIG. 4 shows a business-oriented object model 400 showing an example model of the HCM data as described in the present implementations herein.

In an implementation, the business-oriented object model 400 includes blocks as business-oriented objects. The blocks, for example, are employee 402, position 404, task 406, etc. In this example, the block types are maintained in INFOTYPE 1000 as described above. Furthermore, different blocks have different relations to another block, in which the INFOTYPE 1001 may contain these different relations.

For example, the employee 402 holds a position that is defined by the block-position 404 and at the same time, the employee 402 reports to another employee in the block-employee 402. The relation among these blocks are maintained, for example, by the INFOTYPE 1001. The rest of the INFOTYPES may maintain each business object's attributes and for one business object that contains different INFOTYPEs, the business object may be joined by an object ID (e.g., “view_id).

The model illustrated by the business-oriented object model 400 is powerful and understandable to business-users when the model is provided to the business-user. For example, a manager (not shown) who manages one organizational unit in the organizational unit 412 would like to know KPIs of his or her responsibility such as leaving rates, average age, etc. In addition, the manager would like to see the same KPIs of sub-organizational unit to get detailed information. In this example, the business-oriented object model 400, as further discussed below, may present the model to the manager in order for him to link the KPIs and dimensions that he is looking for from the HCM data. The dimension, for example, is another attribute that is considered by the business-user 302 to his or her search.

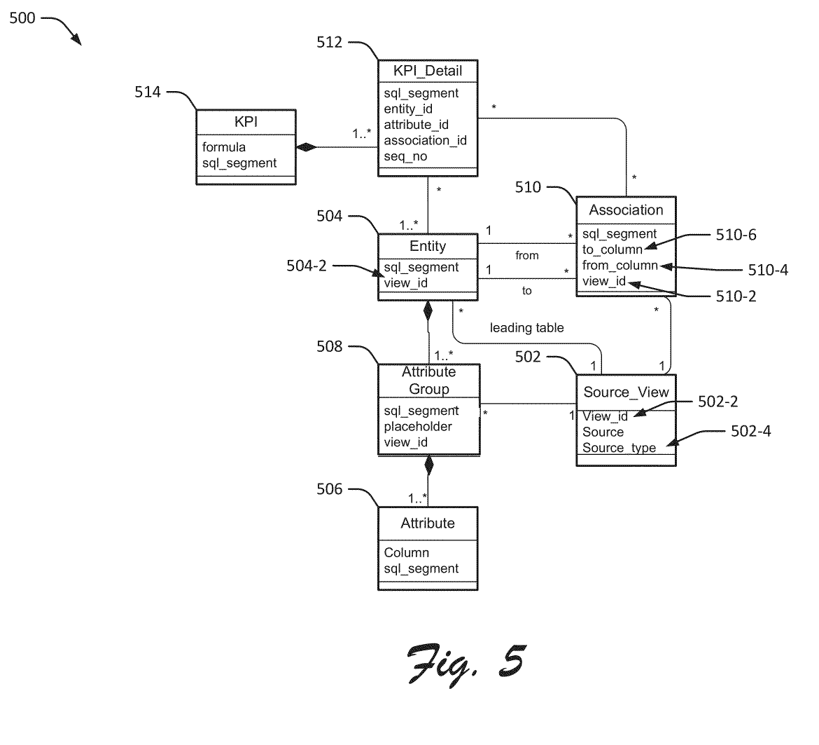

FIG. 5 shows an example database table 500 as described in the present implementations herein. For example, the database table 500 illustrates the business-oriented model for the reporting tool (i.e., the HCM flex analytics and reporting 108), which is configured to have high analytics capability and flexibility as illustrated in FIG. 1.

For modeling of data into business-oriented data, a Source_View 502 is shown in the database table 500 to name an INFOTYPE or flat table from the flat-table data modules. Each source-view has a view_id 502-2 that may be utilized as a reference for other models. Additionally, another information that is carried by this modeling is a source_type 502-4.

The source_type 502-4 may include five values such as:
PA that represents an INFOTYPE of the PA 208-2 module where table-names follow a pattern of PA<0000> to PA<0999>;
PD that represents an INFOTYPE of PD 208-4 module where table-names follow a pattern of ‘HRP<1000>’-‘HRP<1999>’;
‘TM’;
‘PY’;
‘HANA’ that represents the source which is a VDM (Virtual Data Model) in SAP HANA where the VDM is immaterialized views of real database tables.

In an implementation, the source_type 502-4 is utilized by the query generation engine 314 to join different INFOTYPEs or flat-tables. Although all sources are observing a certain pattern in the database table 500, these sources may have minor differences from each other. To this end, source_type 502-4 field is utilized to facilitate how two sources, for example, are combined.

The combination of sources (i.e., defined by source_type 502-4) may include a limited combination. For example, there are 25 combinations for the above 5 types of source_type 502-4. However, for HCM flex analytics and reporting tool 108, PD INFOTYPE 1000, for example, is placed at leading or left most table of the sources to be joined. In other words, a total of five patterns need to be considered in this scenario. They are:
PD INFOTYPE Left Join PD INFOTYPE;
PD INFOTYPE Left Join PA INFOTYPE;
PD INFOTYPE Left Join TM table;
PD INFOTYPE Left Join PY table;
PD INFOTYPE Left Join HANA view.

The above model, may easily extend to support more sources types and it is a reflection of flexibility for the reporting tool described herein.

Another factor in the modeling of data implements an Entity 504, which is shown at middle portion of the database table 500. The Entity 504, for example, may represent the business-oriented objects. Each Entity 504 has a leading table referenced by a view_id 504-2, which is the left most table of the source to be joined. The leading table may decide how many records may be returned in a final dataset. Normally, for example, the leading table is PD INFOTYPE ‘HRP1000’.

With each Entity 504, one or more of its corresponding attribute 506 are further modeled. The number of attribute 506 for each Entity 504 is normally substantial in number and as such, an Attribute_Group 508 is further modeled to classify the attribute 506.

For the PA 208-2 and the PD 208-4, the INFOTYPE is a natural grouping of the attribute 506. Thus, the Attribute_Group 508 maps to an INFOTYPE, and the attribute 506 maps to a field in the INFOTYPE. To this end, the ‘view_id’ exists in both of the Attribute_Group 508 and the attribute 506 in order to maintain flexibility of grouping and so as not to strictly limit the grouping by INFOTYPE. Furthermore, the query generation engine 314 may join resources if the selected attribute 506 are distributed in different INFOTYPEs of one Entity 504.

In an implementation, the attribute 506 is utilized as:
a factor to calculate KPIs; and
a dimension to analyze certain KPIs.

The relation between two or more Entity 504 is modeled by Association 510. The query generation engine 314 may use the Association 510 to join resources from different Entities 504. For example, a ‘view_id’ 510-2 is a reference to the resource where the relations are stored. In this example, a ‘from_column’ 510-4 is an identification (id) to be joined from the source Entity 504, while a ‘to_column’ 510-6 is an id to be joined to the target Entity 504. In an implementation, the PD INFOTYPE 1001 is used by the Association 510.

With continuing reference to FIG. 5, KPI_Detail 512 and KPI 514 represent the modeling of the KPI in the database table 500.

In an implementation, the KPI 514 may be derived from attributes of Entities 504, and the attributes may distributed on several Entities 504, which are connected by the Association 510. To this end, the calculation of the KPI 514 may hold a sequence of information such as which association the Entities 504 are connected to, and what attributes are selected from the Entity 504 to calculate the KPI.

On the other hand, the KPI_Detail 512 is modeled to store the sequence of information above. By storing the sequence of information, the KPI_Detail 512 may receive or is connected to both the Entity 504 and the Association 510. As shown, an ‘entity_id’ of the KPI_Detail 512 references to the entity 504 that carries a needed ‘attribute_id’ while a ‘seq_no’ denotes the sequence and position of current Entity 504.

An ‘association_id’ of the KPI_Detail 512 references to the association 510 with which a current Entity 504 connects to the other Entity 504 in a next sequence number. In all the fields of the KPI_Detail 512, the ‘attribute_id’ and the ‘association_id’ are optional fields. For example, to illustrate:
KPI Average Overtime:

avg(Employee.ActualWorkingHour−OrganizationalUnit.TargetWorkingHourPerEmployee) Formula:

To calculate the KPI Average Overtime, at least two attributes may be required from different Entities 504. Referring back to the business-oriented model in FIG. 4, the Employee 402 holds Position 404, and the Position 404 belongs to Organizational Unit 412. To model this example KPI, the KPI_Detail 512 is written as:

| Seq_no | Entity_id | Attribute_id | Association_id |
|---|---|---|---|
| 0 | Employee | ActualWorkingHour | EmpHoldsPos |
| 1 | Position | | PosBelongsToOrg |
| 2 | OrgUnit | TargetWorkingHourPerEmploy- | |
| | | ee | |

With the above KPI_Detail 512, the KPI changes when the dimension and aggregation level changes. In other words, the KPI calculation is not simply a calculation before aggregation. In most cases, the aggregation may be implemented before the calculation itself. To elaborate this point, we have:
KPI Headcount (aggregation before or after calculation):

KPI=count(Employee) Formula:

The business-user 302, for example, may want to evaluate the above KPI Headcount by dimension. For example, the business-user 302 wants to take into consideration the number of headcounts held by male employees and by senior developers. In this example, the business-user 302 may select more attributes as dimensions out to final dataset. In another example where the business-user 302 needs aggregation such as how many headcounts are held by the organizational unit in the business-user's responsibility, how does it compare to the number of headcounts held by an upper level organizational unit, etc., the calculation of the KPI on the upper level organization unit is implemented, for example, in two ways:

√Calculation before aggregation: KPI=count(KPI Headcount of each sub Organizational Unit)

√Aggregation before calculation: KPI=count(Employee of all organizational Unit)

Both calculations above are correct because the aggregation method ‘count( )’ is transferable.

In another example elaboration for the aggregation, we have:
KPI Average Age (aggregation must be before calculation)

KPI=avg(Employee.age) Formula:

In this example, the business-user 302 may want to evaluate the KPI by dimension. For example, business-user 302 wants to take into consideration the average age of senior managers, average age of female developers, etc. In this example, the business-user 302 may select more attributes as dimensions out to final dataset. In another example where the business-user 302 needs aggregation such as what is the average age of the employees in the organizational unit in the business-user's responsibility and how does it compare to the average age of the employees in the upper level organizational unit, the calculation of the KPI on the upper level organization unit is implemented, for example, not only by averaging the average age of all the organizational units in its sub-tree. Instead, the aggregation is implemented before calculation. For example, aggregate the ages and number of employees, and afterwards, calculate the KPI. This example is illustrated below.

×Calculation before aggregation: KPI=avg(KPI Average Age of each organizational unit)

√Aggregation before calculation: KPI=avg(Employee.age of all organizational unit)

Only the second one above (i.e., with “check” marking) is correct because the aggregation method ‘avg( )’ is untransferable. In general, aggregation may be implemented at the very last step and that the calculation may all be executed before the aggregation.

With continuing reference to FIG. 5, a field ‘sql_segment’ appears on nearly every models. The field ‘sql_segment’ may include a string of where-clause in the SQL query. The field ‘sql_segment’ is maintained in order for the INFOTYPEs to be sometimes reused by several other business-oriented objects that may adopt similar data structure. Furthermore, the reuse function may happen to attributes 506 and associations 510. In this manner, the flexibility for the model above is maintained.

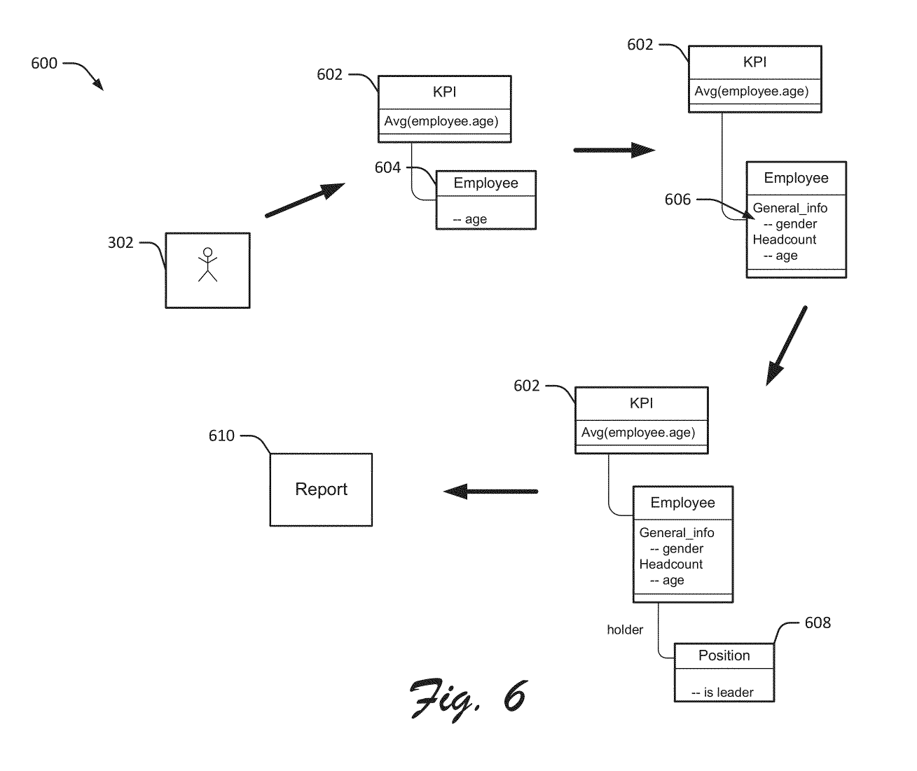

FIG. 6 shows an example scenario 600 for a selection of the subset. The scenario 600, for example, implements a business-oriented modeling similar to the discussions above.

As shown, the business-user 302 may first choose or select KPI 602 out of KPI repository. The selected KPI 602 may include a minimum subset of the modeled HCM data such as, for example the modeled data structure from the modeling 308 component of FIG. 3. For example, the minimum subset may include minimum number of Entity 504, Attributes 506 and Associations 510 to calculate the selected KPI 602.

At a next stage, the business-user 302 selects the dimension on which the KPI 602 is analyzed. Because the whole modeling is substantially large, the business-user 302 may first check if the dimension is an attribute of existing Entity or Entities and select them out. If they are not attributes of the existing Entity or Entities, then the business-user 302 has to know the business context on how the target dimension is connected or related to the KPI. In other words, starting from the last one Entity of the Entities' sequence that are carried by the KPI, the business-user 302 may find the dimension along certain path connected by the Associations 510 and Entities 504.

Using the scenario 600 to elaborate the modeling above, one scenario of subset selection is illustrated as follows.

The business-user 302 is interested in KPI ‘Average Age’ and selects this. With this selection, the Entity ‘Employee’ 604 with Attribute ‘Age’ is brought into work place automatically. Now, the business-user 302 may also want to analyze this KPI by Attribute ‘Gender’ 606 in order to get an idea what is the average age of male or female employees of the ‘Organizational Unit’ of his or her responsibility. Incidentally, the ‘Gender’ is included in the Entity ‘Employee’, so the business-user 302 may choose this attribute to work place.

Thereafter, the business-user 302 may want to add a dimension of ‘IS_LEADER’ to get an idea what is the average age of male manager or female manager. And the Attribute ‘IS_LEADER’ is on ‘Entity Position’608. With these subset selections, the next stage for the business-user 302 to perform is to generate reporting in Report 610.

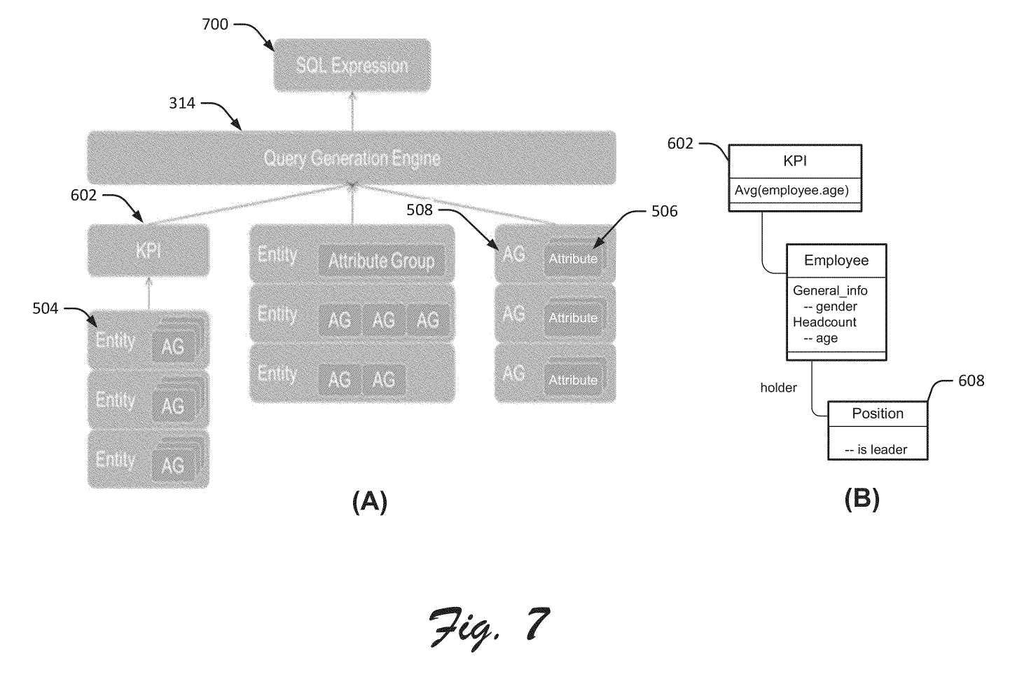

FIG. 7 shows an example implementation of generating the SQL expression by the query generation engine 314 as discussed in the present implementations herein.

In order to get the dataset for generating reports or for further analysis in other third-party reporting tools, the user-defined business model may be dynamically converted by the query generation engine 314 into an SQL expression 700. The SQL expression 700 is an example relational database management systems that may be directly consumed by, for example, SAP HANA (i.e., HANA 210) or any other databases.

As aforementioned, a typical model of the business report consists of the user-defined KPI and the corresponding entity chain, which contains one or more entity 504. The involved entities 504 are connected one by one as a queue and the relationship between them are specified by Associations 510. Each entity 504 consists of several attribute groups 508 (e.g., INFOTYPEs in SAP HCM), which gather attributes 506 of different business aspects into groups. In order to convert the user-defined model into dynamic SQL expression, the query generation engine 314 works in an iterative way.

As shown in FIG. 7(A), the query generation engine 314 firstly generates SQL expression for individual attribute group 508. Based on this output, the query generation engine 314 may then convert entities 504 and then the corresponding KPI 602 into SQL expression iteratively.

For example, as shown in FIG. 7(B), a subset of the KPI average age 602 on Dimension “Gender” and “Is Leader” in the subset of model user specifies Average Age as the KPI and three attributes, i.e. Gender, Age which belong to the entity Employee, and the attribute ‘Is leader’ which belongs to another entity Position.

First step, the query generation engine 314 converts the attribute groups General Info and Headcount of the entity Employee into SQL expression. An output result of this is shown as below. ‘GESCH’ is the internal name of the attribute Gender in SAP HCM, and ‘PA0002’ is the table name for the attribute group General Info. ‘PERNR’ is the key column which is used as the join condition to join attribute groups in the same entity together. ‘BEGDA’, ‘ENDDA’ and ‘MANDT’, which refer to Begin Date, End Date and System Client, are system information used as additional join conditions which ensure that the join action does not generate any redundant rows. All these information are maintained together with the attribute Gender and pre-delivered by query generation engine 314.

```
select PERNR,  GESCH from pa0002
      where BEGDA  <=  ‘20120131’
        and  ENDDA  >=  ‘20120131’
        and  mandt=‘004’;
```

Second step, the attribute groups in the same entity have the same key columns which can be used for the conjunction, for example ‘PERNR’ is the key column of the entity Employee. Hence the query generation engine 314 gets the following SQL expression for the entity Employee, which combines associated attribute groups together using PERNR as the key column.

```
select  T1.PERNR,  T1.GESCH,  T2.AGE from
(
  SQL for GeneralInfo
) as T1
join
(
  SQL for Headcount
) as T2
on T1.PERNR = T2.PERNR
```

The SQL expression result for the entity Position may be generated in the similar way. The association between different entities are maintained automatically and pre-delivered by, for example, the SAP HCM. Using the same example above, a connection is made of the Employee to the Position by Hold Association. The SQL segment, as shown, is ‘RELAT=‘008’ AND RSIGN=‘B’’. ‘OTYPE’—means the source entity while ‘SCLAS’ refers to the target entity. As such, the pseudo SQL expression result for the entity chain is shown as:

```
select PERNR, Gender, Age,  IsLeader from
(
    (
    SQL for Employee
        join
    Select * from HRP1001
    where OTYPE = ‘P’
        AND SCLAS = ‘S’
        AND RSIGN = ‘B’
        AND RELAT = ‘008’
    )
    join
    SQL for Position
)
```

Finally, the query generation engine 314 generates the SQL expression 700 for the KPI Average Age basing on the SQL expression result of the entity chain. The KPI definition 602 contains the associated entities and also formulae which indicate how to calculate the KPI. The query generation engine 314 may be able to convert the pre-defined formulae of the KPI definition 602 into SQL expressions as shown in the example code below. The attributes in the formulae are used as selection criteria and all the other attributes are used in the “GROUP BY” clause for aggregating the result set.

select avg(Age) from
(
SQL for Entities
)
Group by Gender

In the iterative way mentioned above, the query generation engine 314 is able to convert any user-defined model into SQL expression. This includes the KPIs and also the entity chain without KPI specified. The entity chain without the specified KPI may be utilized to generate flat-tables for further analysis.

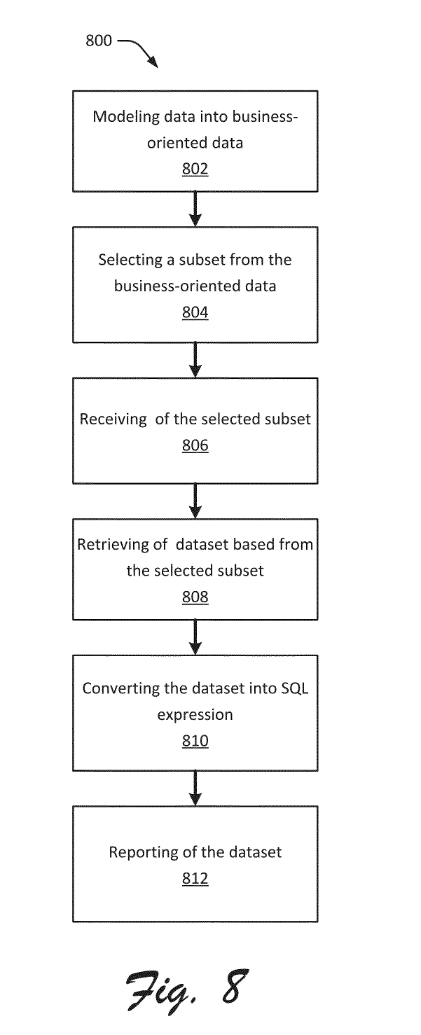

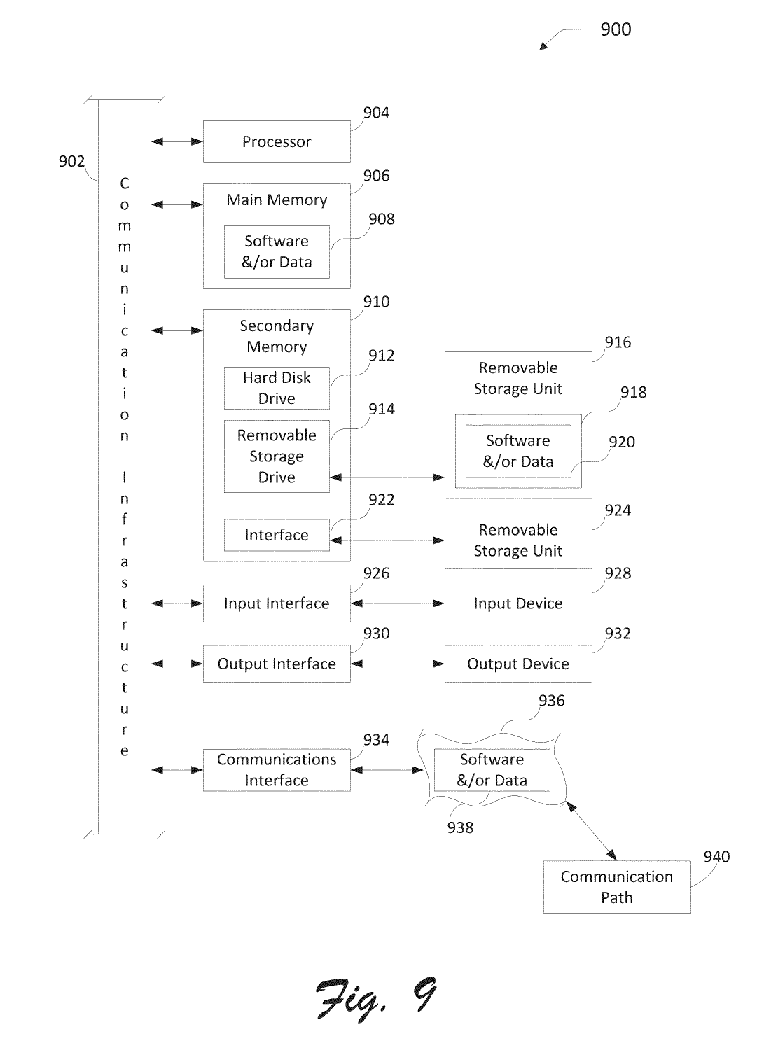

FIG. 8 illustrates an exemplary process 800 for implementing, at least in part, the technology described herein. In particular, process 800 depicts a flow to implement a reporting tool that has a flexible analytics feature. The process 800 may be performed by a computing device or devices. An example architecture of such a computer device is described below with reference to FIG. 9. In this particular example, the process 800 describes that certain acts are to be performed at or by a user or a system.

At 802, modeling of data into business-oriented data is performed. For example, the data includes data modules 208, which are flat-table data modules. In the example, the resulting model may be represented, for example, by database table 500 of FIG. 5.

At 804, selecting a subset from the business-oriented data is performed. For example, the subset is a part of the resulting business-oriented data. In this example, a business-user may first choose a KPI to have a minimum subset, and then the business-user finds the dimension that may be connected by associations and entities.

At 806, receiving of the selected subset is performed. For example, the query generation engine 314 receives the selected subset.

At 808, retrieving of dataset based from the selected subset is performed.

At 810, converting of the dataset into SQL language or expression is performed. For example, the query generation engine 314 converts the retrieved dataset into the SQL language for consumption of third party reporting tools.

At 812, reporting of the dataset is performed. For example the reporting utilizes the SQL expression for the reporting of the dataset.

FIG. 9 illustrates an exemplary system 900 that may implement, at least in part, the technologies described herein. The computer system 900 includes one or more processors, such as processor 904. Processor 904 can be a special-purpose processor or a general-purpose processor. Processor 904 is connected to a communication infrastructure 902 (for example, a bus or a network). Depending upon the context, the computer system 900 may also be called a client device.

Computer system 900 also includes a main memory 906, preferably Random Access Memory (RAM), containing possibly inter alia computer software and/or data 908.

Computer system 900 may also include a secondary memory 910. Secondary memory 910 may include, for example, a hard disk drive 912, a removable storage drive 914, a memory stick, etc. A removable storage drive 914 may comprise a floppy disk drive, a magnetic tape drive, an optical disk drive, a flash memory, or the like. A removable storage drive 914 reads from and/or writes to a removable storage unit 916 in a well-known manner. A removable storage unit 916 may comprise a floppy disk, a magnetic tape, an optical disk, etc. which is read by and written to by removable storage drive 914. As will be appreciated by persons skilled in the relevant art(s) removable storage unit 916 includes a computer usable storage medium 918 having stored therein possibly inter alia computer software and/or data 920.

In alternative implementations, secondary memory 910 may include other similar means for allowing computer programs or other instructions to be loaded into computer system 900. Such means may include, for example, a removable storage unit 924 and an interface 922. Examples of such means may include a program cartridge and cartridge interface (such as that found in video game devices), a removable memory chip (such as an Erasable Programmable Read-Only Memory (EPROM), or Programmable Read-Only Memory (PROM)) and associated socket, and other removable storage units 924 and interfaces 922 which allow software and data to be transferred from the removable storage unit 924 to computer system 900.

Computer system 900 may also include an input interface 926 and a range of input devices 928 such as, possibly inter alia, a keyboard, a mouse, etc.

Computer system 900 may also include an output interface 930 and a range of output devices 932 such as, possibly inter alia, a display, one or more speakers, etc.

Computer system 900 may also include a communications interface 934. Communications interface 934 allows software and/or data 938 to be transferred between computer system 900 and external devices. Communications interface 934 may include a modem, a network interface (such as an Ethernet card), a communications port, a Personal Computer Memory Card International Association (PCMCIA) slot and card, or the like. Software and/or data 938 transferred via communications interface 934 are in the form of signals 936 which may be electronic, electromagnetic, optical, or other signals capable of being received by communications 934. These signals 936 are provided to communications interface 934 via a communications path 940. Communications path 940 carries signals and may be implemented using a wire or cable, fiber optics, a phone line, a cellular phone link, a Radio Frequency (RF) link or other communication channels.

As used in this document, the terms “computer-program medium,” “computer-usable medium,” and “computer-readable medium” generally refer to media such as removable storage unit 916, removable storage unit 924, and a hard disk installed in hard disk drive 912. Computer program medium and computer usable medium can also refer to memories, such as main memory 906 and secondary memory 910, which can be memory semiconductors (e.g. Dynamic Random Access Memory (DRAM) elements, etc.). These computer program products are means for providing software to computer system 900.

Computer programs (also called computer control logic) are stored in main memory 906 and/or secondary memory 910. Such computer programs, when executed, enable computer system 900 to implement the present technology described herein. In particular, the computer programs, when executed, enable processor 904 to implement the processes of aspects of the above. Accordingly, such computer programs represent controllers of the computer system 900. Where the technology described herein is implemented, at least in part, using software, the software may be stored in a computer program product and loaded into computer system 900 using removable storage drive 914, interface 922, hard disk drive 912 or communications interface 934.

The technology described herein may be implemented as computer program products comprising software stored on any computer useable medium. Such software, when executed in one or more data processing devices, causes data processing device(s) to operate as described herein. Embodiments of the technology described herein may employ any computer useable or readable medium, known now or in the future. Examples of computer useable mediums include, but are not limited to, primary storage devices (e.g., any type of random access memory), secondary storage devices (e.g., hard drives, floppy disks, Compact Disc Read-Only Memory (CD-ROM) disks, Zip disks, tapes, magnetic storage devices, optical storage devices, Microelectromechanical Systems (MEMS), and nanotechnological storage device, etc.).

A computing system may take the form of any combination of one or more of inter alia a wired device, a wireless device, a mobile phone, a feature phone, a smartphone, a tablet computer (such as for example an iPad™), a mobile computer, a handheld computer, a desktop computer, a laptop computer, a server computer, an in-vehicle (e.g., audio, navigation, etc.) device, an in-appliance device, a Personal Digital Assistant (PDA), a game console, a Digital Video Recorder (DVR) or Personal Video Recorder (PVR), a cable system or other set-top-box, an entertainment system component such as a television set, etc.

In the above description of exemplary implementations, for purposes of explanation, specific numbers, materials configurations, and other details are set forth in order to better explain the present invention, as claimed. However, it will be apparent to one skilled in the art that the claimed invention may be practiced using different details than the exemplary ones described herein. In other instances, well-known features are omitted or simplified to clarify the description of the exemplary implementations.

The inventors intend the described exemplary implementations to be primarily examples. The inventors do not intend these exemplary implementations to limit the scope of the appended claims. Rather, the inventors have contemplated that the claimed invention might also be embodied and implemented in other ways, in conjunction with other present or future technologies.

Moreover, the word “exemplary” is used herein to mean serving as an example, instance, or illustration. Any aspect or design described herein as exemplary is not necessarily to be construed as preferred or advantageous over other aspects or designs. Rather, use of the word “exemplary” is intended to present concepts and techniques in a concrete fashion. The term “technology,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

Note that the order in which the processes are described is not intended to be construed as a limitation, and any number of the described process blocks can be combined in any order to implement the processes or an alternate process. Additionally, individual blocks may be deleted from the processes without departing from the spirit and scope of the subject matter described herein.

One or more embodiments described herein may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

What is claimed is:

1. A method of implementing an analytics and reporting tool, the method comprising:
modeling data into business-oriented data, wherein the data utilizes flat-table data modules;
selecting a subset from the business-oriented data;
retrieving a dataset based on the subset;
converting the retrieved dataset into structured query language expression; and
reporting the dataset using the structured query language expression.

2. The method according to claim 1, wherein modeling the data is implemented by using:
a Source-View, wherein the Source-View is a name for INFOTYPE or flat table in the flat-table data modules;
an Entity, wherein the Entity represents business-oriented objects; and
attributes of the Entity, wherein the attributes of the Entity map to a field in the Source-View.

3. The method according to claim 2, wherein a key performance indicator is calculated by holding a sequence of information that includes which association the Entities are connected to, wherein the association defines a relationship between the Entities.

4. The method according to claim 2, wherein a key performance indicator is calculated by holding a sequence of information that includes what attributes are selected from the Entity to calculate the key performance indicator.

5. The method according to claim 1, wherein the flat-table data modules include personnel time management and payroll data modules, the personnel time management and payroll data modules are consolidated and transactional data modules.

6. The method according to claim 1, wherein selecting the subset further comprises:
choosing a key performance indicator out of a key performance indicator repository, wherein the chosen key performance indicator includes a minimum subset; and
finding a dimension that is connected by associations and entities.

7. The method according to claim 1, wherein the structured query language expression is consumed by a third party reporting tool.

8. The method according to claim 1 further comprising converting the retrieved subset into a structured query language query.

9. The method according to claim 1 further comprising converting the business-oriented data into dynamic structured query language expression, wherein the converting utilizes an iterative way.

10. The method according to claim 9, wherein the iterative way includes converting first an individual attribute group, wherein based from the conversion of the individual attribute group, Entities are converted next, wherein corresponding key performance indicator is next converted into structured query language expression.

11. One or more computer-readable media storing processor-executable instructions that when executed cause one or more processors to perform operations that facilitate reporting, comprising:
modeling flat-table data modules into business-oriented data;
selecting a subset from the modeled flat-table data modules;
retrieving a dataset based on the subset;
converting the retrieved dataset into structured query language expression; and
reporting the dataset using the structured query language expression.

12. The one or more computer-readable media according to claim 11, wherein modeling the flat-table data modules is implemented by using:
a Source-View, wherein the Source-View is a name for INFOTYPE or flat table in the flat-table data modules;
an Entity, wherein the Entity represents business-oriented objects; and
attributes of the Entity, wherein the attributes of the Entity map to a field in the Source-View.

13. The one or more computer-readable media according to claim 12, wherein a key performance indicator is calculated by holding a sequence of information that includes which association the Entities are connected to, wherein the association defines a relationship between the Entities.

14. The one or more computer-readable media according to claim 12, wherein a key performance indicator is calculated by holding a sequence of information that includes what attributes are selected from the Entity to calculate the key performance indicator.

15. The one or more computer-readable media according to claim 11, wherein the flat-table data modules include personnel time management and payroll data modules, the personnel time management and payroll data modules are consolidated and transactional data modules.

16. The one or more computer-readable media according to claim 11, wherein selecting the subset further comprises:
choosing a key performance indicator out of a key performance indicator repository, wherein the chosen key performance indicator is a minimum subset; and
finding a dimension that is connected by associations and Entities.

17. The one or more computer-readable media according to claim 11 further comprising receiving of the selected subset.

18. A system that facilities a reporting tool to users, the system comprising:
a modeling component that models data into business-oriented data, wherein the data utilizes flat-table data modules;
a design time component that receives the business-oriented data, wherein a subset is selected from the business-oriented data;
a query generation engine that receives the selected subset, wherein the query generation engine retrieves dataset based from the selected subset and converts the retrieved dataset into structured query language expression; and
a runtime component that receives the retrieved dataset and generates a report for the dataset using the structured query language expression.

19. The system according to claim 18, wherein the flat-table data modules include personnel time management and payroll data modules, the personnel time management and payroll data modules are consolidated and transactional data modules.

20. The system according to claim 18, wherein the query generation engine converts the received selected subset into a structured query language query.
